(19) United States
(12) Patent Application Publication
(10) Pub. No.: US 2009/0055896 A1
(43) Pub. Date: Feb. 26, 2009

(54) NETWORK CONNECTION CONTROL PROGRAM, NETWORK CONNECTION CONTROL METHOD, AND NETWORK CONNECTION CONTROL SYSTEM

(76) Inventors: Osamu Aoki, Tokyo (JP); Hiroaki Kawano, Chiba (JP)

Correspondence Address: SCHIFF HARDIN, LLP;PATENT DEPARTMENT, 6600 SEARS TOWER, CHICAGO, IL, 60606-6473, US

(21) Appl. No.: 11/817,699

(22) PCT Filed: Feb. 6, 2006
(86) PCT No.: PCT/JP2006/302011

§ 371 Date: Oct. 14, 2008

(30) Foreign Application Priority Data
Jul. 20, 2004 (EP) 04017128.2

(51) Int. Cl. G06F 21/00

(52) U.S. Cl. 726/3

(57) ABSTRACT

The present invention prevents a computer, which is infected by an unauthorized program such as a virus or spyware when the computer is brought out, from being connected with a secure network such as an intracompany LAN. When a user terminal is started, a connection with the intracompany LAN is attempted. Then, a network connection is temporarily stopped and an environment is compared with the one where the user terminal operated at a previous time. When there is no difference between both of the environments, the connection with the intracompany LAN is restored. However, when it is determined that the user terminal is connected with a network other than the intracompany LAN when the user terminal was operated at a previous time, an inspection for a virus or the like is executed by a USB memory where the latest anti-virus software is stored. After it is confirmed that the user terminal is safe, the connection with the intracompany LAN is restored.

### BACKGROUND

The present invention relates to a network connection control program, a network connection control method, and a network connection control system to prevent a computer in which an unauthorized program, such as a virus or spyware, are stored, from being connected with a secure network, such as an intracompany LAN.

On a secure network, such as an intracompany LAN, it is important to prevent an infection by an unauthorized program, such as a virus or spyware, from outside of the network, and an unauthorized network connection by the computer or the like brought in from the outside. Since the mode of an unauthorized attack to such a secure network is getting more complicated and more diversified, the method for protecting important information in the secure network should maintain a solid network by combining various systems as well.

As a measure against the unauthorized program, such as the virus, the unauthorized program is immediately exterminated when the unauthorized program is received by providing anti-virus software (see, for example, Virus CHASER″ product information, [online], applicant's home page, [searched for on Feb. 5, 2006], the Internet http://www.viruschaser.jp/products/product_vc.html, printed on Aug. 27, 2007) in a computer terminal used in a secure network, besides a method for preventing the infection from the outside by providing a firewall in a gateway with an external network.

In order to prevent an unauthorized connection with the secure network by a computer brought in from the outside, the monitoring system is provided for immediately detecting the connection by the unauthorized computer terminal, for example, by providing the server for monitoring in the secure network, installing the dedicated program in an authorized computer terminal, and communicating with the server for monitoring (see, for example, Inside Information Leak Countermeasure System “Outline of CWAT System”, [online], applicant's home page, [searched for on Feb. 5, 2006], the Internet http://www.iwi.co.jp/product/cwat/cwat_system.html, printed on Aug. 27, 2007). Besides, a technique to identify the authorized terminal by using address data of a computer terminal is disclosed as a technique for controlling the unauthorized computer terminal (see, for example, Japanese Patent Application Laid-open No. 2004-185498).

By using the above-mentioned monitoring system in the secure network, an unauthorized action performed from the inside of the network can be prevented when an unauthorized computer terminal other than an authorized computer terminal is connected with the secure network. However, in the case of using this system, although the security problem does not easily occur when the authorized computer terminal is a fixed on-site computer or the like, the following security problems will occur when a portable laptop computer or the like is used as the authorized computer terminal.

In recent years, a portable laptop computer is often used as a business computer for making a presentation when visiting a counterparty or client, and for working when going on a business trip. In the case of using the laptop computer outside the company, there is no problem when the laptop computer is used only in a stand-alone mode without being connected with the network. However, when the laptop computer is connected with the Internet or the like in the destination, the possibility of permitting an infection by the unauthorized program such as a virus is essentially certain since the environment with high security like the intracompany secure network is not constructed.

Thus, one tries to connect the laptop computer that is infected by the unauthorized program with the intracompany secure network at the destination, the connection is permitted and the unauthorized program is allowed to infect the secure network since the laptop computer is defined as an authorized computer terminal. In particular, when the unauthorized program operates an unauthorized action not only in the laptop computer but also in the network, a serious issue has been created.

### SUMMARY

The present invention solves this problem, and aims at providing a network connection control program, a network connection control method, and a network connection control system for preventing the computer, which is infected by the unauthorized program such as a virus or spyware in the destination or the like, from being directly connected with the secure network, such as an intracompany LAN.

In order to solve such a problem, various embodiments of the present invention comprise a network connection control program for preventing a computer in which an unauthorized program is stored from being connected with a secure network. The network connection control program is characterized in that the computer where a processing for connecting with a network is started executes the steps of: stopping a processing for connecting with the network executed by the network connection program stored in the computer; reading first environmental information which concerns a connection environment to the secure network, and which is stored in the computer; reading second environmental information which concerns a connection environment to the network where the computer operated at a previous time, and which is stored in the computer; comparing the first environmental information with the second environmental information, and determining that the environment where the computer operated at a previous time was the connection environment other than the secure network when the first environmental information does not match with the second environment; starting an inspection program which inspects whether or not an unauthorized program is stored in the computer, and which is read from the computer or an external storage device connected with the computer, when it is determined that the environment where the computer operated at a previous time was the connection environment other than the secure network; and starting the processing for connecting with the network by the network connection program when the unauthorized program is not detected in the computer by the inspection program.

The present invention may be characterized in that the computer executes the step of: executing at least one of a) processing for starting a restoring program for restoring the unauthorized program and b) processing for establishing the communication with a monitor terminal connected with the secure network and sending an alert message to the monitor terminal when the unauthorized program is detected in the computer by the inspection program.

In various embodiments of the present invention, the environmental information on the secure network such as the intracompany LAN is defined in the computer beforehand. When the computer is started, the environmental information on the secure network defined in the computer beforehand is compared with environmental information that was saved to the computer when the computer operated at a previous time.

When it is determined that the computer was connected with the network other than the secure network at a previous time, the computer is inspected to determine whether or not the unauthorized program such as a virus has infected the computer by the inspection program, such as an anti-virus software. As a result of the inspection, when it is confirmed that the virus or the like is not detected, the network connection is permitted. Accordingly, it can be guaranteed that only the computer that has been confirmed to have no infection by the virus or the like is connected with the secure network when considering the computer which was connected with the network other than the secure network at a previous time.

Moreover, as a result of the inspection, when the virus or the like is detected, it is possible to prevent the computer that is connected with the network other than the secure network and is infected by the virus or the like from being directly connected with the secure network by executing the restoring processing, such as the expulsion of the virus or the like and the processing for sending an alert warning to the monitor terminal that monitors the secure network.

Furthermore, the present invention may be characterized in that the computer executes the steps of: connecting with the network where only a communication with the monitor terminal connected with the secure network is permitted, and determining that the network is not the secure network when it is not possible to communicate with the monitor terminal; and starting the processing for connecting with the network executed by the network connection program when it is determined that the network is not the secure network.

Thus, when the computer is started, only a communication with the monitor terminal connected with the secure network is permitted between the computer and the network. As a result, it can be determined that the connection is made with the secure network when the communication with the monitor terminal can be established, whereas the connection is made with other network when the communication with the monitor terminal cannot be established. When it is determined that the communication is made with other network, the connection can be immediately permitted without executing the virus inspection or the like since the communication is not made with the secure network.

Furthermore, various embodiments of the present invention may be characterized in that the computer executes the steps of: connecting with the network to collect third environmental information on a connection environment to the network, and acquiring the third environmental information; comparing the second environmental information with the third environmental information, and determining that the computer can be connected with the network when the second environmental information matches with the third environmental information; and starting the processing for connecting with the network executed by the network connection program when it is determined that the computer can be connected with the network.

Thus, when the computer is started, only a communication necessary to collect the connection environment to the network is permitted between the computer and the network. As a result, when the connected environment is the same as the environment where the computer operated at a previous time, it can be at least confirmed that the computer connected with the external network previous time is not connected with the intracompany secure network. When it is determined that the connection environment to the network has not changed, the connection can be immediately permitted without executing the virus inspection or the like since the computer connected with the external network previous time is not connected with the secure network. In addition, in this pattern, an operation executed when both of the connection environments to the network do not match with is not especially limited. For example, when the third connection environment is not the intracompany secure network, it may be configured so as to permit the connection at once.

Furthermore, in the step of starting the inspection program, the present invention may be characterized in that an update time or version information of the inspection program which is read from the computer or the external storage device connected with the computer is acquired, and the step of executing the processing for connecting with the network is not executed when a predetermined requirement in order to certify the update time or the version information as the latest program by the inspection program is not satisfied.

It is necessary to include the definition corresponds to the latest virus or the like for effectively operating the inspection program such as an anti-virus software program used in the present invention. Whether or not the inspection program is the latest can be determined based on whether or not an update is executed within the predetermined time period, or whether or not the version is the latest, or the like. The processing for connecting with the network is not executed as long as the inspection program is not updated to the latest version in some embodiments.

Furthermore, a network connection control method by the network connection control program according to various embodiments of the present invention is a network connection control method for preventing a computer where an unauthorized program is stored from being connected with a secure network. The network connection control method is characterized by the steps of: stopping, by a computer where a processing for connecting with a network is started, the processing for connecting with the network executed by a network connection program stored in the computer; reading, by the computer, first environmental information which concerns a connection environment to the secure network, and which is stored in the computer; reading, by the computer, second environmental information which concerns a connection environment to the network when the computer operated at a previous time, and which is stored in the computer; comparing, by the computer, the first environmental information with the second environmental information, and determining that the environment where the computer operated at a previous time was the connection environment other than the secure network when the first environmental information does not match with the second environment; starting, by the computer, an inspection program which inspects whether or not an unauthorized program is stored in the computer, and which is read from the computer or the external storage device connected with the computer, when it is determined that the environment where the computer operated at a previous time was the connection environment other than the secure network; and starting, by the computer, the processing for connecting with the network executed by the network connection program when the unauthorized program is not detected in the computer by the inspection program.

Moreover, the network connection control method according to various embodiments of the present invention may be characterized by the step of: executing, by the computer, at least one processing of processing for starting a restoring program for restoring the unauthorized program, or processing for establishing the communication with a monitor terminal connected with the secure network and sending an alert message to the monitor terminal, when the unauthorized program is detected in the computer by the inspection program.

Furthermore, the network connection control method according to various embodiments of the present invention may be characterized by the steps of: connecting, by the computer, with the network where only a communication with the monitor terminal connected with the secure network is permitted, and determining that the network is not the secure network when it is not possible to communicate with the monitor terminal; and starting, by the computer, the processing for connecting with the network by the network connection program when it is determined that the network is not the secure network.

Furthermore, the network connection control method according to various embodiments of the present invention may be characterized by the steps of: connecting, by the computer, with the network to collect third environmental information on a connection environment to the network, and acquiring the third environmental information; comparing, by the computer, the second environmental information with the third environmental information, and determining that the computer can be connected with the network when the second environmental information matches with the third environmental information; and starting, by the computer, the processing for connecting with the network by the network connection program when it is determined that the computer can be connected with the network.

Furthermore, in the step of starting the inspection program, the network connection control method according to various embodiments of the present invention may be characterized in that an update time or version information of the inspection program which is read from the computer or the external storage device connected with the computer is acquired, and the step of executing the processing for connecting with the network by the computer is not comprised when a predetermined requirement in order to certify the update time or the version information as the latest program by the inspection program is not satisfied.

Furthermore, a network connection control system where the network connection control program according to various embodiments of the present invention is stored is a network connection control system for preventing a computer where an unauthorized program is stored from being connected with a secure network. The network connection control system is characterized by: network connection mechanism for executing the processing for connecting with a network by the computer; connection processing stopping mechanism for stopping the processing for connecting with the network executed by the network connection mechanism when the computer is started; first environmental information store for storing first environmental information on the connection environment to the secure network; second environmental information store for storing second environmental information on a connection environment to the network where the computer operated at a previous time; environmental information comparing mechanism for comparing the first environmental information with the second environmental information by reading the first environmental information from the first environmental information store, and by reading the second environmental information from the second environmental information store; connection environment determining mechanism for determining that an environment where the computer operated at a previous time is connection environment other than the secure network when the first environmental information does not match with the second environment in the environmental information comparing mechanism; and inspection program starting mechanism for starting an inspection program which inspects whether or not the unauthorized program is stored in the computer, and which is read from the computer or an external storage device connected with the computer when it is determined that the environment where the computer operated at a previous time was the connection environment other than the secure network in the connection environment determining mechanism; wherein the processing for connecting with the network by the network connection mechanism is started when the unauthorized program is not detected in the computer by the inspection program which was started by the inspection program starting mechanism.

Moreover, the network connection control system according to various embodiments of the present invention may be characterized by the execution of: at least one processing of processing for starting a restoring program for restoring the unauthorized program, or processing for establishing the communication with a monitor terminal connected with the secure network and sending an alert message to the monitor terminal, when the unauthorized program is detected in the computer by the inspection program which was started by the inspection program starting mechanism.

Furthermore, the network connection control system according to various embodiments of the present invention may be characterized by: secure network determining mechanism for connecting with the network where only a communication with the monitor terminal connected with the secure network is permitted, and determining that the network is not the secure network when it is not possible to communicate with the monitor terminal; wherein the processing for connecting with the network by the network connection mechanism is started when it is determined that the network is not the secure network by the secure network determining mechanism.

Furthermore, the network connection control system according to various embodiments of the present invention may be characterized by: environmental information acquiring mechanism for connecting with the network to collect third environmental information on a connection environment to the network, and acquiring the third environmental information; and second connection environment determining mechanism for comparing the second environmental information with the third environmental information, and determining that the computer can be connected with the network when the second environmental information matches with the third environmental information; wherein the processing for connecting with the network by the network connection mechanism is started when it is determined that the computer can be connected with the network by the second connection environment determining mechanism.

Furthermore, in the inspection program starting mechanism, the network connection control system according to various embodiments of the present invention may be characterized in that an update time or version information of the inspection program which is read from the computer or the external storage device connected with the computer is acquired, and the processing for connecting with the network by the network connection mechanism is not executed when a predetermined requirement in order to certify the update time or the version information as the latest program by the inspection program is not satisfied.

Thus, various embodiments of the present invention prevent the computer that is connected with the network and infected by an unauthorized program such as a virus or spyware when the computer is brought out from being directly connected with the secure network such as the intracompany LAN. As a result, only the computer where the inspection for the virus or the like is executed can be connected, and it becomes possible to ensure the security of the secure network such as the intracompany LAN.

### BRIEF DESCRIPTION OF DRAWINGS

The invention is illustrated below with reference to the drawings and following descriptive text which illustrate various embodiments of the invention.

FIG. 1 is a pictorial schematic outlining embodiments of a network connection control program according to an embodiment of the present invention;

FIG. 2 is a block diagram showing a configuration of a computer in which the network connection control program according to an embodiment of the present invention is stored;

FIG. 3 is a flow chart showing a flow of a first method for determining a connection environment to the network in the network connection control program according to an embodiment of the present invention;

FIG. 4 is a flow chart showing a flow of a second method for determining a connection environment to the network in the network connection control program according to an embodiment of the present invention;

FIG. 5 is a flow chart showing a flow of a third method for determining a connection environment to the network in the network connection control program according to an embodiment of the present invention; and

FIG. 6 is a flow chart showing a flow for determining whether or not the network connection can be permitted in the network connection control program according to an embodiment of the present invention.

### DETAILED DESCRIPTION OF THE PREFERRED EMBODIMENTS

Hereinafter, the best mode for carrying out the present invention will be explained in detail using the drawings. Note herein that specific processing procedures, such as a method for stopping a network connection, a method for restoring a network connection, and a method for communicating with a monitor terminal described below, are merely examples of embodiments for the present invention. Therefore, the present invention is not limited to the following examples of the embodiments.

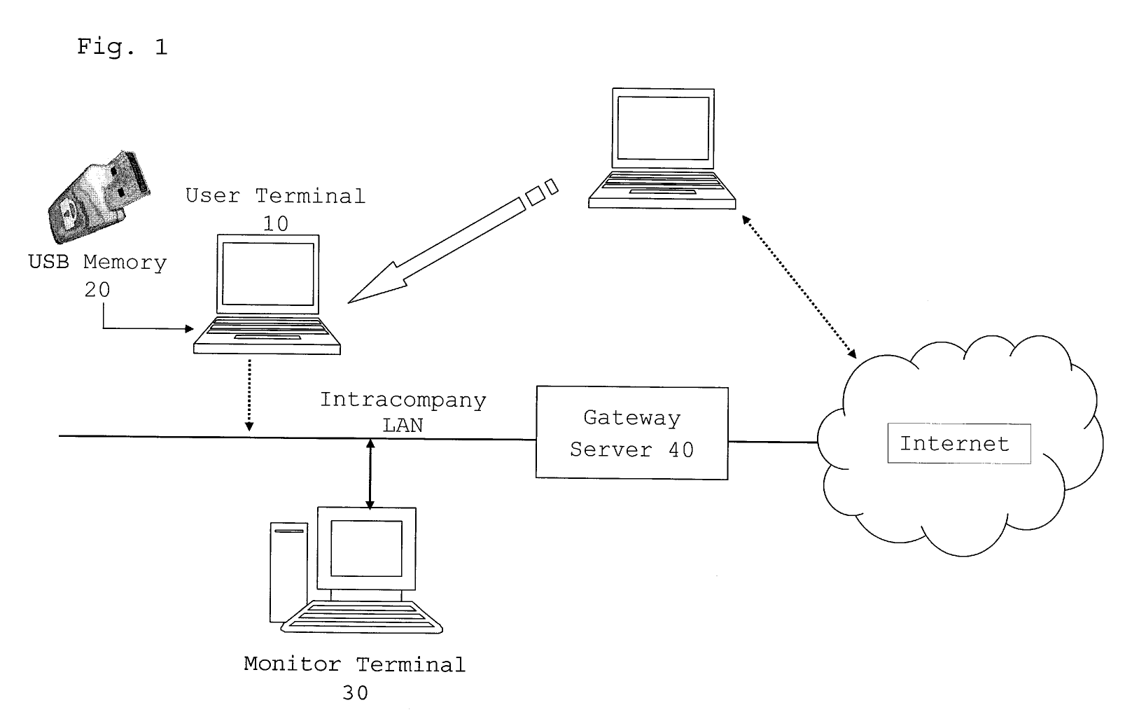

The network connection control program according to various embodiments of the present invention is used in the mode shown in an example of FIG. 1. The network connection control program is stored in a user terminal 10 that is a portable computer such as a laptop computer, and is permitted to connect with an intracompany LAN that is a secure network. The user terminal 10 is usually used by being connected with the intracompany LAN.

The portable user terminal 10 may be connected with an open network such as the Internet when the portable user terminal 10 is brought out of the company since the portable user terminal 10 can be used for making a presentation when visiting a counterparty or client, or working when going on a business trip. When the portable user terminal 10 is connected with the network outside the company, the risk of permitting the infection by an unauthorized program such as a virus or spyware increases compared to the intracompany LAN where the environment with high security is constructed.

When the user terminal 10 used outside the company is brought back in the company, since the user terminal 10 itself have been defined as an authorized terminal in the intracompany LAN, the connection with the intracompany LAN shall be permitted. However, when the user terminal 10 is infected with a virus or the like, and in particular, when the virus that the user terminal 10 is infected operates on the network and occurs an unauthorized influence, the security of the network will be violated from the inside, even if a gateway server 30 prevents the unauthorized program from an external network from invading.

Then, when the user terminal 10 is started, the network connection control program temporarily stops a connecting operation to the intracompany LAN, and executes the processing for connecting with the intracompany LAN after it is confirmed that the user terminal 10 is not infected, by the inspection for the virus or the like.

However, it is inefficient to execute the virus inspection or the like every time for the computer that is not taken out of the company, and a decrease in convenience can be caused. Therefore, it may be configured so as to execute the inspection for the virus or the like only when it is confirmed that the previous connection environment was a network other than the intracompany LAN by confirming the previous connection environment when the network connection is executed. Thus, it becomes possible to guarantee the security of the intracompany LAN by reliably executing the quarantine program on the computer that will be connected with the intracompany LAN.

In order to guarantee the security of the intracompany LAN, it is not an essential requirement to inspect for a virus regardless of the previous connection environment when the user terminal 10 tries to be connected with the network outside the company. Therefore, for example, the network connection control program may be configured so as to permit the network connection without executing the inspection for the virus or the like when it is determined that the user terminal 10 is not connected with the intracompany LAN. The computer can be configured so only the communication through the intracompany LAN can be executed between the user terminal 10 and the monitor terminal 30, which monitors the intracompany LAN, while the network connection has been stopped, and which is before the inspection for the virus or the like, by trying to communicate with the monitor terminal 30 when the user terminal 10 is started, and by determining whether or not the user terminal 10 is connected with the intracompany LAN.

Moreover, to guarantee the security of the intracompany LAN, it is not an essential requirement to inspect for the virus or the like when the user terminal 10 is continuously used by being connected with the network outside the company, even when the previous connection environment is the network outside the company. Therefore, for example, the network connection control program may be configured so as to permit the network connection without executing the inspection for the virus or the like when it is confirmed that the previous connection environment has not changed, by being configured so only the communication necessary to collect the information on the connection environment to the network can be executed while the network connection has been stopped, and which is before the inspection for the virus or the like, and by collecting the environmental information on the connected network when the user terminal 10 is started.

In either of the above-mentioned patterns, an anti-virus software that resides in the user terminal 10 may be used for the inspection for the virus or the like. However, since it is necessary to connect with the network in order to keep the anti-virus software that resides in the computer up-to-date, it is preferable to use an external storage device where the anti-virus program with the latest definition is stored. It is preferable to use a USB memory 20 that makes the anti-virus software start automatically, although the kind of the external storage device is not limited to this.

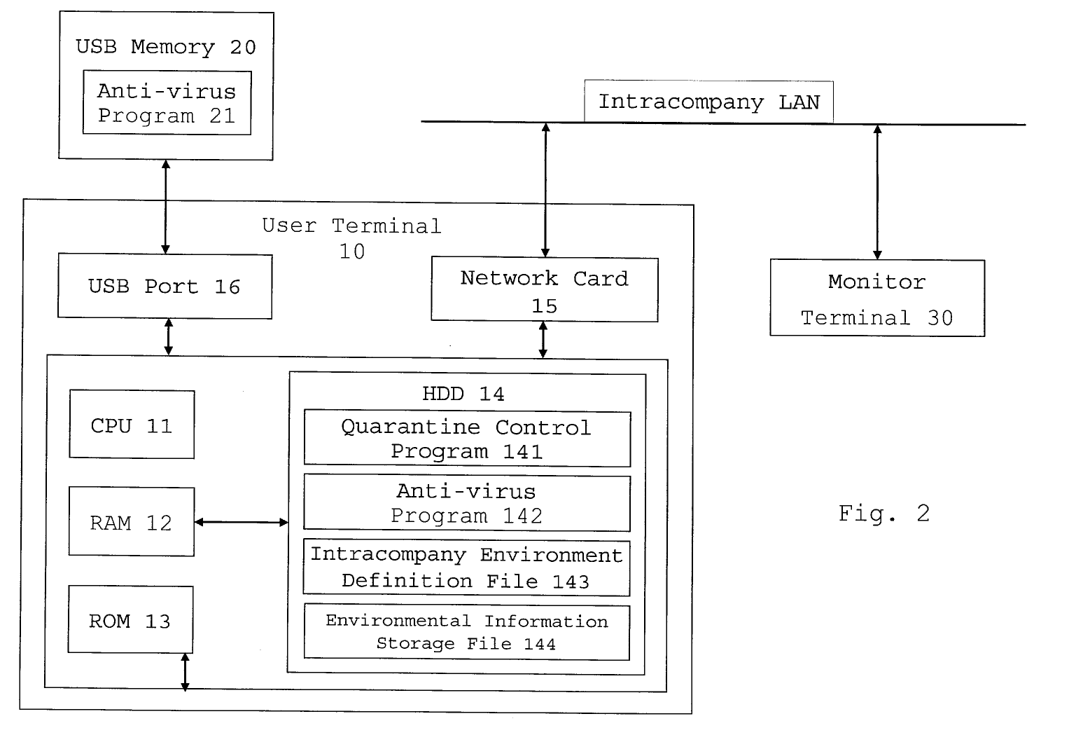

In FIG. 2, a CPU 11, a RAM 12, a ROM 13, an HDD 14, a network card 15, and a USB port 16 are included in the user terminal 10, such as a laptop computer, where the network connection control program according to various embodiments of the present invention is stored. A USB memory 20 where an anti virus program 21 is stored can be connected with the USB port 16. A quarantine control program 141, an intracompany environment definition file 143, and an environmental information storage file 144 are stored in the HDD 14, and an anti virus program 142 may be stored in the HDD 14 in an embodiment that does not use the USB memory 20.

In order to execute the predetermined processing by an application program such as the quarantine control program 141 stored in the HDD 14, basic and various programs for the hardware control such as the input control and the output control stored in the ROM 13 are started, and an operation processing is executed by the CPU 11, operating the RAM 12 as a work area of the application program.

When the user terminal 10 is started, the operating system is read, the network card 15 is initialized by a network driver in usual processing, and the connection with the intracompany LAN is performed. However, in an embodiment of the present invention, the processing for connecting with the network is stopped by the operation of the network driver or the quarantine control program 141. In addition, the processing for stopping the network connection may be executed at a hardware level by providing a program that executes the processing for stopping the network connection on a BIOS or the like in the network card 15, besides the processing for stopping the network connection at a driver level.

When the processing for connecting with the network is stopped, the connection environment to the network where the user terminal 10 operated at a previous time is confirmed. The information on the connection environment to the intracompany LAN that the user terminal 10 is permitted to connect to is stored as the intracompany environment definition file 143 in the HDD 14. On the other hand, the information on the connection environment to the network where the user terminal 10 operated at a previous time is stored as the environmental information storage file 144 in the registry of the operating system or the HDD 14.

The connection environment to the network executed by the quarantine control program 141 is confirmed as follows. The information on the connection environment to the network where the user terminal 10 operated at a previous time is read from the registry value or the environmental information storage file 144, the information on the connection environment to the intracompany LAN is read from the intracompany environment definition file 143, and it is determined whether or not the connection environment where the user terminal 10 operated at a previous time was the intracompany LAN by comparing both of the information elements on the connection environment. When both of the information elements on the connection environment matches, it is determined that the connection environment where the computer operated at a previous time was the intracompany LAN.

If the connection environment where the computer operated at a previous time is the intracompany LAN, the processing for restoring the network connection is executed, since it is confirmed that it was used in an environment with high security. The method for restoring the network connection is not especially limited. For example, it is indirectly communicated that the network card is newly added to the operating system, and usual processing for initializing may be executed to the network card 15 by a function of Plug and Play. Moreover, the transmission of the information to the network card 15 is inhibited by using a filter driver, and the network connection may be executed by releasing the inhibition.

In addition, the method for determining whether or not the network connection can be permitted is not limited to the above-mentioned method. When it can be confirmed that the user terminal 10 is trying to be connected with the network outside the company, the network connection may be directly permitted regardless of the previous connection environment. In this case, the network connection control program may be configured so as to permit the network connection when it is determined that the user terminal 10 is not connected with the intracompany LAN by being configured so only the communication through the intracompany LAN can be executed between the user terminal 10 and the monitor terminal 30, which monitors the intracompany LAN, by the quarantine control program 141 while the network connection has been stopped, by trying to communicate with the monitor terminal 30 when the user terminal 10 is started, and by determining whether or not the user terminal 10 is connected with the intracompany LAN.

Moreover, when it can be confirmed that the user terminal 10 is in the connection environment where the user terminal 10 operated at a previous time, the network connection may be directly permitted since it becomes clear that the user terminal 10 that has been connected with the external network is not connected with the intracompany LAN. In this case, the network connection control program may be configured so as to permit the network connection when it is determined that the environment is the same as the information on the connection environment to the network, where the user terminal 10 operated at a previous time and which is read from the registry value or the environmental information storage file 144, by being configured so only the communication necessary to collect the information on the connection environment to the network can be executed by the quarantine control program while the network connection has been stopped, and by collecting the environmental information on the connected network when the user terminal 10 is started.

In either of the above-mentioned cases, when it is determined that a requirement that the network connection can be immediately permitted is not satisfied, the inspection is executed by the anti-virus software or the like in order to determine whether or not the unauthorized program such as a virus or spyware have infected the user terminal 10.

For example, the screen that requires the USB memory 20, in which the anti-virus program 21 kept up-to-date is stored, is displayed by the operation of the quarantine control program 141, and the user inserts the USB memory 20 into the USB port 16. Then, the anti-virus program 21 is automatically started by the operation of the USB memory 20, and the virus check is run on the user terminal 10.

The storage medium where the anti-virus program 21 is stored is not limited to the USB memory 20, and the flexible disk, CD-ROM, or the like may be used. However, when it is not possible to operate an automatic start like when using the USB memory, it is necessary to request an operation such as clicking the execution file by the user himself.

The inspection for the virus or the like can be executed by reading the anti-virus program 142 stored in HDD 14. However, since it is necessary to connect with the network and access a server for the update in order to keep the anti-virus program 142 up-to-date, it is necessary to apply a device to execute the inspection that reflects the latest definition. This can be achieved, for example, by determining that the definition is the latest when the elapsed time period from the previous update time recorded in the anti-virus program 142 is within the predetermined time period, or by determining whether or not the version information recorded in the anti-virus program 142 is the latest. When the anti-virus program 142 is not kept up-to-date, the processing for restoring the network connection is not executed, or the update is executed by permitting only a communication with the server for the update in order to reflect the latest definition on the anti-virus program 142. The update of the anti-virus program 142 may be executed not by connecting through the network but by connecting with the external storage device such as a flexible disk.

When the virus or the like is not detected as a result of the inspection executed in the user terminal 10 by reading the anti-virus program 21 or 142, the processing for restoring the network connection is immediately started by the quarantine control program 141. Although the method for restoring the network connection is the same as the one explained above, the inspection for the virus or the like can be completed by directly detecting the virus or the like by the quarantine control program 141, or by writing the time or the like, when the inspection for the virus or the like is completed, in the registry by the anti-virus program 21 or 142 and then detecting the completion of the inspection for the virus or the like by consistently monitoring the registry by the quarantine control program 141. The alert warning may be transmitted to the monitor terminal 30 by the operation of the quarantine control program 141 when the network connection is restored.

On the other hand, when the virus or the like is detected as a result of the inspection by the anti-virus program 21 or 142, the restoration of the detected virus or the like is immediately executed. However, when it is determined that the detected virus or the like can not be restored, the processing for restoring the network connection is not executed in order to ensure the security of the intracompany LAN.

When the restoration of the virus or the like is executed, the processing for restoring the network to the intracompany LAN is executed. Although the method for restoring the network connection is the same as the one explained above, the restoration of the virus or the like can be completed by directly detecting the virus or the like by the quarantine control program 141, or by writing the time and the like, when the virus is restored, in the registry by the anti-virus program 21 or 142 and then detecting the restoration of the virus or the like by consistently monitoring the registry by the quarantine control program 141. It is preferable to transmit the alert warning to the monitor terminal 30 in order to inform the detection of the virus, the kind of the detected virus, and the like by the operation of the quarantine control program 141 when the virus or the like is restored, and the network connection is restored.

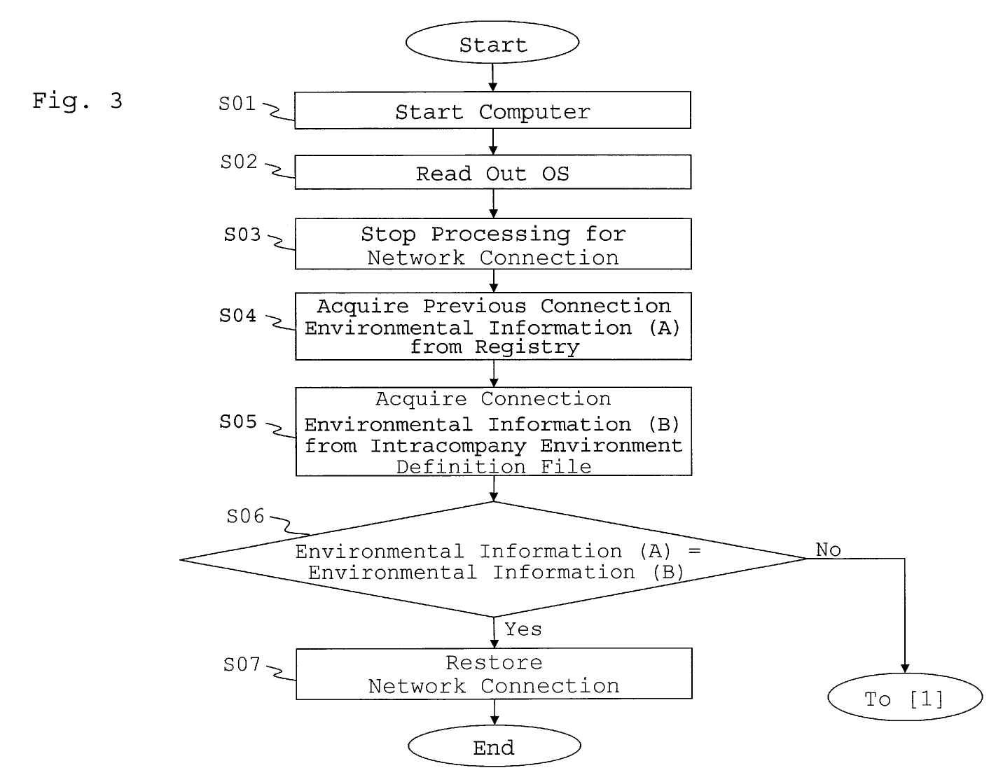

The flow of a first embodiment for determining a connection environment to the network in the network connection control program according to the present invention will be explained by using the flow chart of FIG. 3. In the following flow, the area or the like where the connection environmental information is stored is not especially limited. Whether the specific processing for stopping or restoring the network connection is executed at the driver level or the hardware level is not especially limited, as well.

When a computer is started (S01), an operating system is read (S02). However, the processing for immediately stopping an operation for the network connection is executed among operations by the operating system (S03). Continuously, environmental information (A) that is information on the connection environment to the network when the computer operated at a previous time is acquired from a registry of the operating system (S04). Furthermore, environmental information (B) that is information on the usual connection environment to an intracompany LAN or the like is acquired from a file that defines the network environment inside the company (S05).

Then, it is compared whether or not the environmental information (A) and the environmental information (B) matches (S06). When both of the environmental information elements match, it is determined that the computer is continuously used under the environment where the computer is connected with the intracompany LAN, and the processing for restoring the network connection is executed (S07). Then, the processing related to the network connection control is completed. When both of the environmental information does not match, it is shifted to a processing for determining whether or not the network connection can be permitted based on the inspection for the virus or the like.

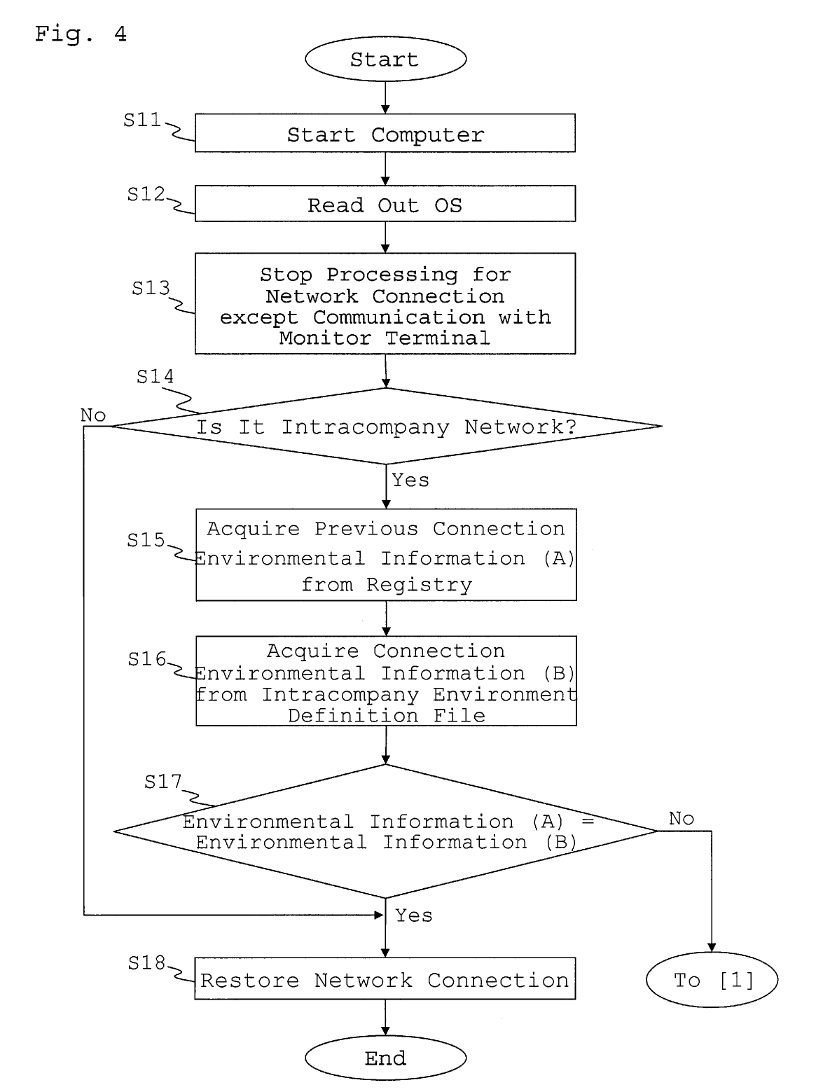

The flow of a second embodiment for determining a connection environment to the network in the network connection control program according to the present invention will be explained by using the flow chart of FIG. 4. In the following flow, it can be also said that the area or the like where the connection environmental information is stored nor the specific processing for stopping or restoring the network connection are not especially limited.

When the computer is started (S11), the operating system is read (S12). However, the processing for immediately stopping an operation for the network connection except a communication with a monitor terminal is executed among operations by the operating system (S13). The connection with the monitor terminal is tried through the intracompany network, and then it is determined whether or not the connection environment of the computer is the intracompany network based on whether or not the connection is permitted (S14).

When the communication with the monitor terminal cannot be executed, and it is determined that the connection environment of the computer is not the intracompany network, the processing for restoring the network connection is directly executed since it is not necessary to execute the quarantine for a network connection outside the company (S18), and then the processing related to the network connection control is completed. On the other hand, when it is determined that the connection environment of the computer is the intracompany network, environmental information (A) that is information on the connection environment to the network where the computer operated at a previous time is acquired from the registry of the operating system (S15). Furthermore, environmental information (B) that is information on the usual connection environment to an intracompany LAN or the like is acquired from a file that defines the network environment inside the company (S16).

Continuously, it is compared whether or not the environmental information (A) and the environmental information (B) match (S17). When both of the environmental information match, it is determined that the computer is continuously used under the environment where the computer is connected with the intracompany LAN, and the processing for restoring the network connection is executed (S18). Then, the processing related to the network connection control is completed. When both of the environmental information elements do not match, it is shifted to processing for determining whether or not the network connection can be permitted based on the inspection for the virus or the like.

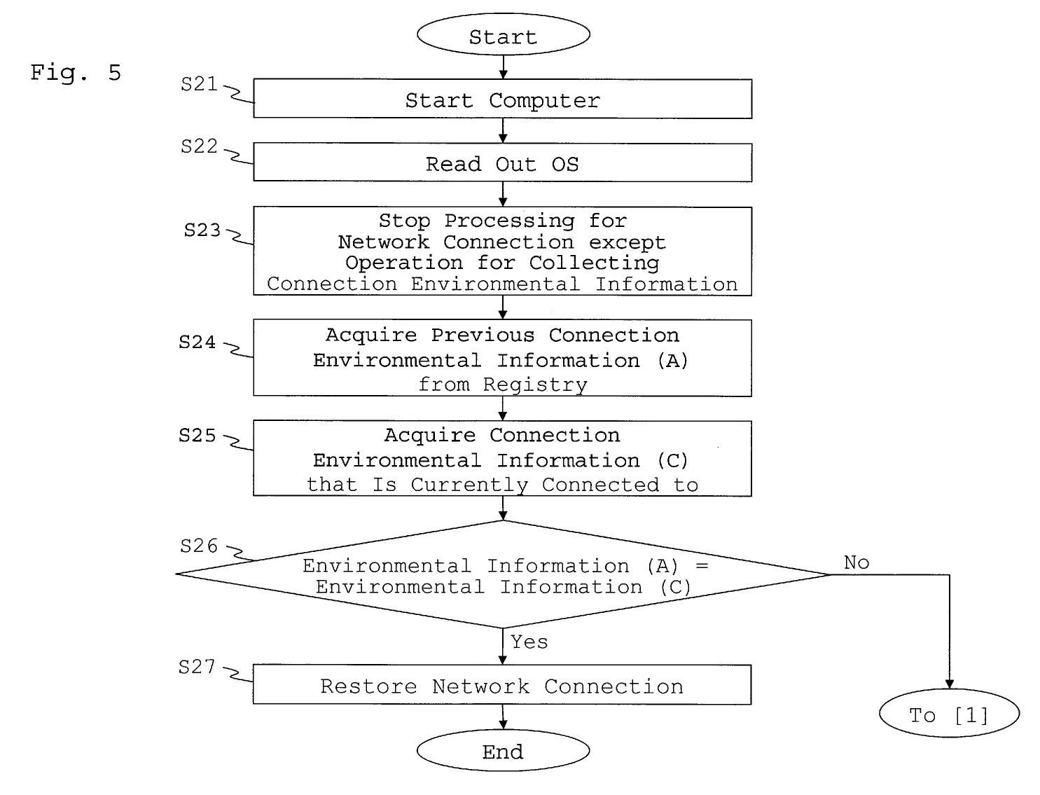

The flow of a third embodiment for determining a connection environment to the network in the network connection control program according to the present invention will be explained by using the flow chart of FIG. 5. In the following flow, it can be also said that the area or the like where the connection environmental information is stored nor the specific processing for stopping or restoring the network connection are not especially limited.

When the computer is started (S21), the operating system is read (S22). However, the processing for immediately stopping an operation for the network connection except an operation for collecting connection environmental information to the network is executed among operations by the operating system (S23). Continuously, the environmental information (A) that is information on the connection environment to the network where the computer operated at a previous time is acquired from a registry of the operating system (S24). Furthermore, environmental information (C) that is information on the connection environment collected from the currently connected network is acquired (S25).

Then, it is compared whether or not the environmental information (A) and the environmental information (C) match (S26). When both of the environmental information elements match, it is determined that the computer is continuously used under the same environment as the computer operated at a previous time, and the processing for restoring the network connection is executed (S27). Then, the processing related to the network connection control is completed. When both of the environmental information does not match, it is determined that there is a possibility that the computer is brought in from outside the company since the environment where the computer operated at a previous time has changed. Therefore, it is shifted to processing for determining whether or not the communication with the network can be permitted based on the inspection for the virus or the like. The operation performed when both of the environmental information elements do not match is not limited to the above example. For example, when it is determined that the connected environment is not the intracompany LAN by comparing the environmental information B and the environmental information C, the processing for restoring the network connection may be executed.

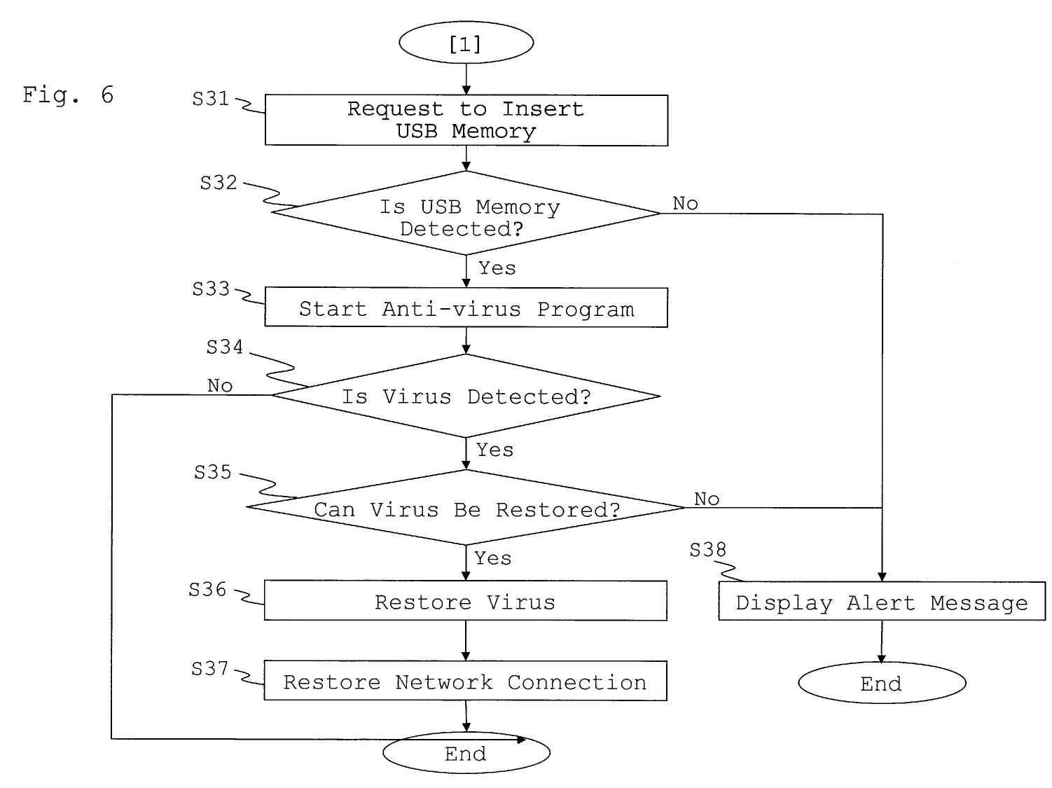

The determination flow, which shows the case where it is needed to determine whether or not the network connection can be permitted in the first embodiment through the third embodiment, by the network connection control program according to various embodiments of the present invention will be explained by using the flow chart of FIG. 6. In the following flow, although anti-virus software is assumed to be detected from a USB memory, a medium where the anti-virus software is stored is not limited to the USB memory, and the anti-virus software stored in other external storage medium or the computer itself may be used. Moreover, the target of the inspection may be not only the virus but also other unauthorized programs such as spyware.

When it is determined that it is necessary to confirm whether or not the virus or the like exists inside the computer due to the disagreement of the connection environmental information, the dedicated USB memory is requested to be inserted in order to start the anti-virus software which is kept up-to-date (S31). When the USB memory is not detected (S32), an alert message is displayed since the inspection for the virus cannot be executed (S38), and the processing for restoring the network connection is not executed.

When the USB memory is detected (S32), the anti-virus software read from the USB memory is started (S33), and the inspection for the virus is executed. When the virus or the like is not detected by the inspection (S34), the processing for restoring the network connection is executed (S37), and the processing related to the network connection control is completed.

When the virus or the like is detected by the inspection (S34), the detected virus is restored (S36) when the virus can be restored (S35). Then, the processing for restoring the network connection is executed (S37), and the processing related to the network connection control is completed. On the other hand, when the detected virus cannot be restored (S35), an alert message is displayed since the virus cannot be restored (S38), and the processing for restoring the network connection is not executed.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language with the various algorithms being implemented with any combination of data structures, objects, processes, routines or other programming elements. The invention can be implemented in a computer running any operating system or any other operating system on a computer system ranging from a personal laptop or palmtop to mainframe servers, where applicable. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### TABLE OF REFERENCE CHARACTERS

10 User terminal
11 CPU
12 RAM
13 ROM
14 HDD
141 Quarantine control program
142 Anti-virus program
143 Intracompany environment definition file
144 Environmental information storage file
15 Network card
16 USB port
20 USB memory
21 Anti-virus program
30 Monitor terminal
40 Gateway server

1-15. (canceled)

16. A network connection control program stored in a memory of a computer and executable on a processor of the computer for preventing a computer where an unauthorized program is stored from being connected with a secure network, the network connection control program comprising:
software for stopping a processing for connecting with the network executed by the network connection program stored in the computer;
software for reading first environmental information which concerns a connection environment to the secure network, and which is stored in the computer;
software for reading second environmental information which concerns a connection environment to the network where the computer operated at a previous time, and which is stored in the computer;
software for comparing the first environmental information with the second environmental information, and determining that the environment where the computer operated at a previous time was a connection environment other than the secure network when the first environmental information does not match with the second environment;
software for starting an inspection program which inspects whether or not an unauthorized program is stored in the computer, and which is read from the computer or an external storage device connected with the computer when it is determined that the environment where the computer operated at a previous time was the connection environment other than the secure network; and
software for starting processing for connecting with the network executed by the network connection program when the unauthorized program is not detected in the computer by the inspection program.

17. The program according to claim 16, further comprising:
software for executing at least one of: a) processing for starting a restoring program for restoring the unauthorized program, and b) processing for establishing the communication with a monitor terminal connected with the secure network and sending an alert message to the monitor terminal, when the unauthorized program is detected in the computer by the inspection program.

18. The program according to claim 16, further comprising:
software for connecting with the network where only a communication with a monitor terminal connected with the secure network is permitted, and determining that the network is not the secure network when it is not possible to communicate with the monitor terminal; and
software for starting the processing for connecting with the network executed by the network connection program when it is determined that the network is not the secure network.

19. The program according to claim 16, further comprising:
software for connecting with the network to collect third environmental information on a connection environment to the network, and acquiring the third environmental information;
software for comparing the second environmental information with the third environmental information, and determining that the computer can be connected with the network when the second environmental information matches with the third environmental information; and
software for starting the processing for connecting with the network executed by the network connection program when it is determined that the computer can be connected with the network.

20. The program according to claim 16, wherein, software for starting the inspection program comprises:
software for reading an update time or version information of the inspection program from the computer or the external storage device connected with the computer is acquired, and the step of executing the processing for connecting with the network is not executed when a predetermined requirement in order to certify the update time or the version information as the latest program by the inspection program is not satisfied.

21. A network connection control method for preventing a computer where an unauthorized program is stored from being connected with a secure network, comprising:
stopping, by a computer where a processing for connecting with a network is started, the processing for connecting with the network executed by a network connection program stored in the computer;
reading, by the computer, first environmental information concerning a connection environment to the secure network, the first environmental information stored in the computer;
reading, by the computer, second environmental information which concerns a connection environment to the network where the computer operated at a previous time, and which is stored in the computer;
comparing, by the computer, the first environmental information with the second environmental information, and determining that the environment where the computer operated at a previous time was a connection environment other than the secure network when the first environmental information does not match with the second environment;
starting, by the computer, an inspection program which inspects whether or not an unauthorized program is stored in the computer, and which is read from the computer or the external storage device connected with the computer when it is determined that the environment where the computer operated at a previous time was the connection environment other than the secure network; and
starting, by the computer, the processing for connecting with the network executed by the network connection program when the unauthorized program is not detected in the computer by the inspection program.

22. The method according to claim 21, further comprising the step of:
executing, by the computer, at least one of: a) processing for starting a restoring program for restoring the unauthorized program, and b) processing for establishing the communication with a monitor terminal connected with the secure network and sending an alert message to the monitor terminal, when the unauthorized program is detected in the computer by the inspection program.

23. The method according to claim 21, further comprising the steps of:
connecting, by the computer, with the network where only a communication with the monitor terminal connected with the secure network is permitted, and determining that the network is not the secure network when it is not possible to communicate with the monitor terminal; and
starting, by the computer, the processing for connecting with the network executed by the network connection program when it is determined that the network is not the secure network.

24. The method according to claim 21, further comprising the steps of:
connecting, by the computer, with the network to collect third environmental information on a connection environment to the network, and acquiring the third environmental information;
comparing, by the computer, the second environmental information with the third environmental information, and determining that the computer can be connected with the network when the second environmental information matches with the third environmental information; and
starting, by the computer, the processing for connecting with the network executed by the network connection program when it is determined that the computer can be connected with the network.

25. The method according to claim 21, wherein, the step of starting the inspection program comprises:
reading an update time or version information of the inspection program which is read from the computer or the external storage device connected with the computer, and the step of executing the processing for connecting with the network by the computer is not executed when a predetermined requirement in order to certify the update time or the version information as the latest program by the inspection program is not satisfied.

26. A network connection control system for preventing a computer where an unauthorized program is stored from being connected with a secure network, and the network connection control system comprising:
a network connection for executing a processing for connecting with a network of the computer;
a connection processing stopping mechanism for stopping the processing for connecting with the network executed by the network connection means when the computer is started;
a first environmental information store for storing first environmental information on the connection environment to the secure network;
a second environmental information store for storing second environmental information on a connection environment to the network where the computer operated at a previous time;
an environmental information comparing mechanism for comparing the first environmental information with the second environmental information by reading the first environmental information from the first environmental information store, and by reading the second environmental information from the second environmental information store;
a connection environment determining mechanism for determining that an environment where the computer operated at a previous time is connection environment other than the secure network when the first environmental information does not match with the second environment in the environmental information comparing mechanism; and
an inspection program starting mechanism for starting an inspection program which inspects whether or not the unauthorized program is stored in the computer, and which is read from the computer or the external storage device connected with the computer when it is determined that the environment where the computer operated at a previous time was the connection environment other than the secure network in the connection environment determining mechanism; wherein
the processing for connecting with the network by the network connection mechanism is started when the unauthorized program is not detected in the computer by the inspection program which was started by the inspection program starting mechanism.

27. The system according to claim 26, wherein
at least one of: a) processing for starting a restoring program for restoring the unauthorized program, and b) processing for establishing the communication with a monitor terminal connected with the secure network and sending an alert message to the monitor terminal is executed, when the unauthorized program is detected in the computer by the inspection program which was started by the inspection program starting mechanism.

28. The system according to claim 26, further comprising:
a secure network determining mechanism for connecting with the network where only a communication with the monitor terminal connected with the secure network is possible, and determining that the network is not the secure network when it is not possible to communicate with the monitor terminal; wherein
the processing for connecting with the network executed by the network connection mechanism is started when it is determined that the network is not the secure network by the secure network determining mechanism.

29. The system according to claim 26, further comprising:
an environmental information acquiring mechanism for connecting with the network to collect third environmental information on a connection environment to the network, and acquiring the third environmental information; and
a second connection environment determining mechanism for comparing the second environmental information with the third environmental information, and determining that the computer can be connected with the network when the second environmental information matches with the third environmental information; wherein
the processing for connecting with the network executed by the network connection mechanism is started when it is determined that the computer can be connected with the network by the second connection environment determining mechanism.

30. The system according claim 26, wherein, the inspection program starting mechanism comprises:
a mechanism for reading an update time or version information of the inspection program which is read from the computer or the external storage device connected with the computer, and the processing for connecting with the network executed by the network connection mechanism is not executed when a predetermined requirement in order to certify the update time or the version information as the latest program by the inspection program is not satisfied.
